(19) United States
(12) Patent Application Publication
(10) Pub. No.: US 2021/0182963 A1
(43) Pub. Date: Jun. 17, 2021

(54) System and Process for Option Trading

(71) Applicant: OptionNalytics Pte. Ltd., Singapore (SG)

(72) Inventor: David Prasert TANG, Singapore (SG)

(21) Appl. No.: 17/003,650

(22) Filed: Aug. 26, 2020

(30) Foreign Application Priority Data
Jun. 28, 2019 (SG) 10201906050Q

(51) Int. Cl. G06Q 40/04; G06Q 40/06

(52) U.S. Cl. CPC G06Q 40/04; G06Q 40/06

(57) ABSTRACT

The present invention discloses an option trading system which executes a trading campaign in accordance with the conditions of an option strategy, wherein the option contracts making up each option position are grouped and processed as a whole.

### RELATED APPLICATIONS

This application claims the benefit of priority under 35 U.S.C. § 119 to Singapore Application No. 10201906050Q, filed Jun. 28, 2019, the disclosure of which is hereby incorporate by reference in its entirety.

### TECHNICAL FIELD

The present invention relates to a system and process for option trading.

### BACKGROUND

An option position is a combination of buying and selling option contracts with different strikes and expiration dates. Popular option positions such as iron condors, butterflies, calendars and vertical spreads are traded by retail and institutional option traders around the world and, in many cases, computers have been used to process option trading strategies and carry out option trading or provide traders with options trade alerts, which are prompts for entering, modifying and exiting these positions.

However, when dealing with a slew of different option positions within the same trading account such as two or more butterflies or a combination or condors and vertical spreads, a trader whilst modifying an existing position may inadvertently make changes in an option contract which actually belongs to another position.

As existing software applications may process option contracts individually, there is a high risk that an option contract belonging to another position may be traded together with the option contracts for the intended position, hence resulting in inaccurate hedging and higher risk of loss.

There remains a need to have a simpler, more accurate and efficient system and process for executing options which prevents inadvertent trading of option contracts.

### SUMMARY

Existing software applications may process option contracts individually, so there is a high risk that an option contract belonging to another position may be traded together with the option contracts for the intended position, hence resulting in incorrect hedging and higher risk of loss.

The present invention solves this problem by processing the option contracts of an option position as a whole/a group.

For example, an iron butterfly option position is made up of 4 option contracts. These 4 option contracts which make up the iron butterfly position are processed by the system as an option object and not as 4 individual contracts.

This method of managing option contracts and option positions is advantageous and is a key contributor to the efficiency and speed of the system as it reduces process steps when monitoring and managing options.

Dynamic data of the group of option contracts as a whole are derived from the aggregate of dynamic data of the individual contracts therein. A common quantity which is a single positive integer is generated for the group, which is based on the quantity values of the plurality of option contracts in the group. The group is processed as a whole using these aggregate data and common quantity.

Trigger conditions for entering, adjusting, or exiting a position, such as strike price or price movement, are consistently checked against the current aggregate data and market conditions until the trigger conditions are satisfied. Once the trigger conditions are satisfied, the option contracts can be executed on the basis of the common quantity.

Processing a plurality of option contracts under the same option position streamlines the process of exercising options and managing trade positions.

### BRIEF DESCRIPTION OF THE DRAWINGS

FIG. 1 shows an overview of the process of executing a trading campaign for the plurality of option contracts as a group or groups between the strategy module, data processing module, and external sources.

FIG. 2 shows an embodiment of the data processing module comprising information on option objects, option positions, market data, and strategies used.

FIG. 3 shows an example of position symbols of the various trade positions required by an option strategy.

FIGS. 4a, 4b, and 4c show an embodiment of option object data which is aggregated, stored, and tracked in the data processing module.

FIG. 5 shows an example of downloaded historical data for the purposes of back testing.

FIG. 6a shows the flow of data for entering an option position. Component values such as total credit received is checked against trigger conditions for entering an option position, the satisfaction of which will generate an entry command.

FIG. 6b shows an example of an option position being entered.

FIGS. 7a and 7b show the flow of data for adjusting an option position. Component values such as current quantity and strike prices are retrieved and checked against trigger conditions, the satisfaction of which will generate an adjustment command.

FIGS. 7c and 7d show examples of an option position adjustment.

FIG. 8a shows the flow of data for exiting an option position, also known as closing an entire position. Component values such as VIX values are retrieved and checked against the trigger conditions, satisfaction of which will generate an exit command.

FIGS. 8b and 8c shows an example of when a required trigger condition is met and an exit command is generated.

FIG. 8c shows an example of when a required trigger condition is not met, and an exit command is not generated, i.e. nothing happens.

### DETAILED DESCRIPTION

In the following detailed description, reference is made to the accompanying drawings which form a part hereof. The processes and systems described in the detailed description and drawings are for illustrative purposes and are not meant to be limiting. Other embodiments can be utilized, and other changes can be made, without departing from the scope of the disclosure presented herein. In the present disclosure, depiction of a given element or consideration or use of a particular element number in a particular Fig. or a reference thereto in corresponding descriptive material can encompass the same, an equivalent, or an analogous element or element number identified in another Fig. or descriptive material associated therewith.

In the following detailed description, an individual option held by a trader is referred to as an option contract, which gives a trader the right to buy or sell an underlying security at a strike price on or before a certain date. Examples of option contract types are CALL (contract to buy) option and PUT (contract to sell) option, and CALL or PUT options can both be bought or sold. Several option contracts can together form an option position such as a vertical, an iron butterfly or an iron condor position. An option is ‘at the money’ (ATM) if the strike price is the same as the current price of the underlying security.

An option position is formed from a combination of buying and selling option contracts with different strikes and expiration dates. For example, a 50-point ATM Iron Butterfly with underlying stock priced at $990 could have an option position with 4 option contracts and 4 different strike prices: PUT $940, PUT $990, CALL $990, and CALL $1040. If the market is entered with a purchase (debit) of 10 Iron Butterflies, the position would be PUT $940 (debit 10 or +10), PUT $990 (credit 10 or −10), CALL $990 (credit 10 or −10), and CALL $1040 (debit 10 or 10). The debit or credit operation is effected upon entering the option position.

A trader can have more than one option position. The option positions of a trader are collectively called a trade position. A trade position changes whenever an option position changes. An option strategy or option trading strategy is a set of rules specifying conditions for when a trader should enter a trade position or option position, when the trade or option position should be adjusted and when the trader should exit the trade or option position.

In the above example, the option strategy may require going into a second butterfly position at a later time also based on a 50-point ATM Iron Butterfly. If the underlying stock price at that time is $1100, the second butterfly will have the following option contracts—PUT $960 (debit 10), PUT $1100 (credit 10), CALL $1100 (credit 10), CALL $1060 (debit 10). The trade position will have 2 butterflies, and the strategy is the set of rules determining when to enter the first or second butterfly or when to close either one or both butterflies.

The present invention discloses an option trading system which executes a trading campaign in accordance with the conditions of an option strategy, wherein the option contracts making up each option position are grouped and processed as a whole, as option objects. In the above example, the 2 butterflies may be processed as 2 option objects.

This system can be used in back testing or live trading. In back testing, historical market data is used to test the option strategy. In live trading, real time market data is applied to the option strategy.

The System

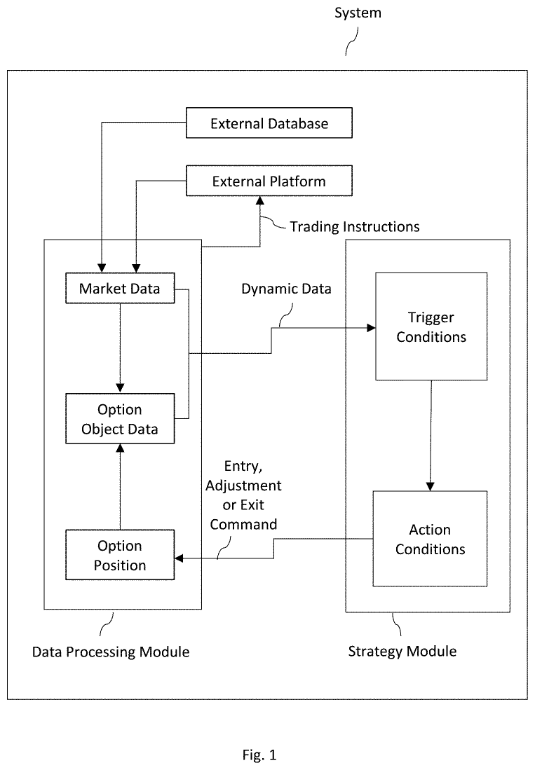

The system, as illustrated by FIG. 1, comprises a data processing module and a strategy module. The data processing module and the strategy module may be programmed to work communicatively by processing data sent to and received from each other.

The system of FIG. 1 may be one or more computers (e.g., server(s)) and include, for example, one or more processors configured by software, such as a CPU (Central Processing Unit), GPU (graphics processor), controller, etc.. The data processing module and the strategy module may be functional modules of the computer(s). The computer may be a general purpose computer or may be dedicated hardware or firmware (e.g., an electronic or optical circuit, such as application-specific hardware, such as, for example, a digital signal processor (DSP) or a field-programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein (e.g., the data processing module, the strategy module, external database, external platform, etc.) may be hardwired and/or in the form of data (e.g., as data stored in and retrieved from memory of the computer, such as a register, buffer, cache, storage drive, etc., such as part of an application programming interface (API)). The functional modules of the computer(s) may each correspond to a separate segment or segments of software (e.g., a subroutine) which configure the computer(s) and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script. The external database and storage of the computer(s) may comprise conventional memory of a computer, such as a hard drive (which may be a solid state drive, DRAM, NAND flash memory, etc.). Such computer(s) may comprise a conventional computer user interface and include convention input devices, such as a keyboard, mouse, trackpad, touchscreen, etc. to allow user interaction, such as described herein. Software to execute the methods described herein may be stored on a non-transitory computer readable medium, such as that described herein or other conventional computer memory/storage.

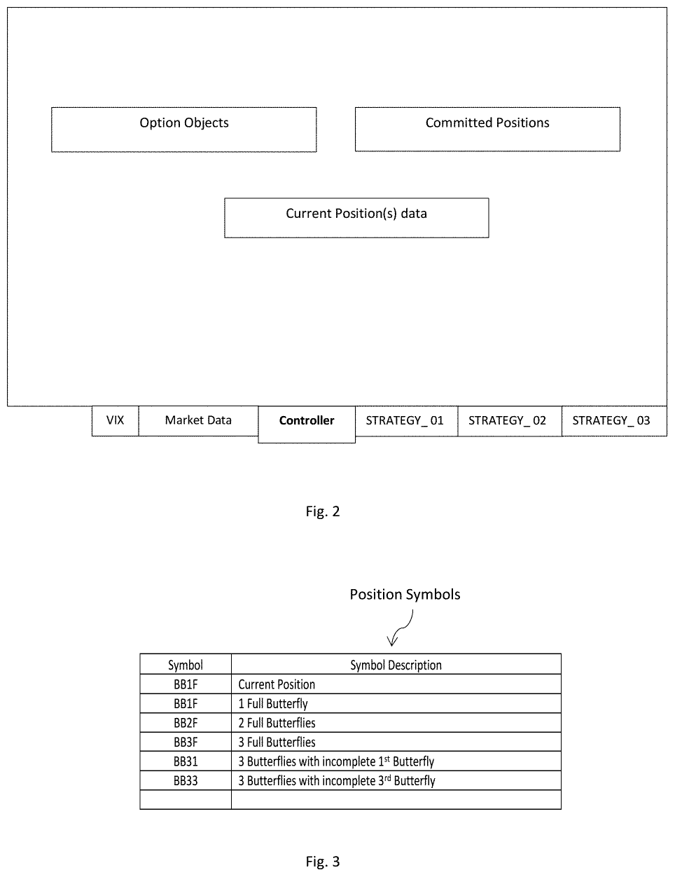

As shown in FIG. 2, an embodiment of the data processing module may include information such as market data and option strategies being used. The data processing module primarily retrieves, sends, and stores information.

The strategy module is configured to contain all the trading conditions, rules and decisions of an option strategy. The strategy module serves to check options data against the conditions of an option strategy and send commands to enter, adjust, or exit an option position once the corresponding conditions are met.

The data processing module retrieves information such as market data from an external database and information from the strategy module, stores information such as data on the option objects and option positions, and sends information such as market data to the strategy module and trading instructions to an external trading platform. Data regarding option objects and trade positions are processed in a Controller within the data processing module.

In an embodiment, the data processing module is a spreadsheet engine plugin using formulas, macros and VBA. In an embodiment, the strategy module may be programmed to work communicatively with the data processing module within the same spreadsheet engine, such as Microsoft Excel. The strategy module may be in Microsoft Excel binary format with “.xlsb” file extension.

The modularity of the elements of the system enhances the adaptability of a strategy module such that it can be used easily with more than one data processing module. For example, a strategy module can be used easily with more than one spreadsheet engine.

Position Symbols

The strategy module may be configured to store information on all possible trade positions specified in the strategy. Each trade position is assigned a unique symbol (or tag) by the Strategy Module.

In an embodiment, the current trade position is identified and its position symbol generated using spreadsheet formula. If there is no current position, the position symbol may be ‘NIL’. FIG. 3 shows a strategy where the entire strategy is made up of Butterfly positions such as ‘1 Full Butterfly’, ‘2 Full Butterflies’, ‘3 Full Butterflies’, etc. A Butterfly is a type of option position. In FIG. 3, the current trade position is “1 Full Butterfly” and has been assigned the symbol ‘BB1F’. The formula used for checking current position may depend on the option strategy as defined in the strategy module. For the strategy shown in FIG. 3, the formula checks the number of Butterfly and generates the corresponding trade position symbol. A possible pseudo code of the algorithm of the formula to generate a trade position symbol is as follows:

| | |
|---|---|
| If | |
| | current position has 1 Full Butterfly |
| then | |
| | set current position data cell value as BB1F |
| else if | |
| | current position has 2 Full Butterflies |
| then | |
| | set current position data cell value as BB2F |
| else if | |
| | current position has 3 Full Butterflies |
| then | |
| | set current position data cell value as BB3F |
| else if | |
| | current position has 3 Butterflies and |
| | 1^{st} Butterfly has less than full quantity |
| then | |
| | set current position data cell value as BB31 |
| else if | |
| | current position has 3 Butterflies and |
| | 3^{rd} Butterfly has less than full quantity |
| then | |
| | set current position data cell value as BB33 |
| else | |
| | set current position data cell value as NIL |
| end if | |

The current trade position data may be used by the system to determine the next position. For example, if the current position is ‘NIL’, then the next trade position will be an entry position. If the current position is not ‘NIL’, then the next trade position will be determined according to the strategy.

Conditions

The set of rules of an option strategy will be hereinafter referred to as “trigger conditions” as they trigger the execution of a trade—entering, adjusting, or exiting an option position. Trigger conditions for an option position relate to the market data such as Days to Expiration (DTE; the number of days until an option expires), VIX values, Greek data, strike price, etc. which are common market conditions traders look out for when making trade decisions. The trigger conditions also relate to finance data such as investment capital, percentage of profit/loss of investment capital, credit received, etc. which concern the investor's capital. Since the price of the underlying security changes over time, this data will also change as the trading campaign progresses over time. This is known as dynamic data.

‘VIX’ refers to a measure of the expectation of the stock market's volatility. In an embodiment, it refers to the Chicago Board Options Exchange (CBOE) Volatility Index. Greek data include Delta, Vega, Theta and Gamma values, which are statistical values measuring an option contract's sensitivity to changes such as the underlying security's price, volatility and time decay.

Once trigger conditions have been met, the strategy module generates a command to enter or adjust an option position. In this description, adjusting an option position can include exiting the current position entirely.

The system not only utilises trigger conditions, but also action conditions. Action conditions are defined herein as the action that the option strategy specifies should be taken once trigger conditions have been satisfied.

For example, a trigger condition of DTE≤7 days is satisfied, and the action condition is to modify the common quantity of the option object (thereby modifying the quantity of each option contract therein) to become “0” thus exiting the option position.

Option Object

The individual option contracts which make up an option position are processed as a collective group referred to in this description as “option object”. These option objects are created in the strategy module and stored and tracked in the data processing module. Option objects have 2 values: a unique identifier (ID) and a single positive integer value which is the quantity of the option object. As option contracts have depreciating value over time, it is common for traders to ensure that when selling options, they have a corresponding buying of the same quantity of options (with different strike prices or expiration dates). Buying an option contract (debit contracts) bears the risk of the full loss of the value of the option, and selling an option contract (credit contracts) bears the risk of unlimited loss. For example, a trader may sell 10 option contracts at $320 strike price and mitigate that risk by buying 10 $340 strike price of the same option type (PUT or CALL).

An option object can comprise 1 to 4 option contracts. The strategy module assigns an option object a unique ID and a common quantity to the option contracts, the common quantity being a positive integer value. An option object is created by generating the unique ID and the common quantity required. The system identifies and processes an option object based on its unique ID and its aggregate data. The system can process a plurality of option contracts as a whole, in the form of option objects, for a plurality of option positions, in accordance with trigger conditions and action conditions for each option position as defined in the strategy module based on an option strategy. The option contracts are executed on the basis of the action conditions, which in part dictate the common quantity or quantities of the relevant option object(s).

In an embodiment, the following command is generated to create an option object for an iron butterfly option position having a common quantity of 10:

ADD ID=P2530/P2630/C2630/C2730 QTY=10

The command above comprises an instruction “ADD”, an option object ID of “P2530/P2630/C2630/C2730” and a common quantity of 10. The command above can be generated by the strategy module when the system is executing a trading campaign in accordance with an option strategy.

The following command comprises an instruction “MODIFY” which is used to increase the common quantity of the iron butterfly option position by 4 from the initial 10 units:

MODIFY ID=P2530/P2630/C2630/C2730 QTY=14

The following command is used to reduce the common quantity of the iron butterfly option position by 7 from the initial 10 units:

MODIFY ID=P2530/P2630/C2630/C2730 QTY=3

The following command is used to exit the iron butterfly option position and close the option object:

MODIFY ID=P2530/P2630/C2630/C2730 QTY=0

In the embodiment above, the option object ID “P2530/P2630/C2630/C2730” contains information of the individual option contracts which make up the iron butterfly option position. The option type (P for PUT and C for CALL) and the strike prices (2530, 2630 and 2730) of each the 4 option contracts are represented in the option object ID separated by a ‘/’ marker.

During creation of an option object, the strategy module calculates the highest common factor among the quantities of the required option contracts and transforms the data such that every option contract within an option object has a common quantity. For example, an option position may have the following option contracts:
CALL2530 +10
CALL2630 −20
CALL2730 +10

In the above case, the option contracts do not have a common quantity. Accordingly, the strategy module identifies a highest common factor among the quantities and creates an option object with this value as the common quantity. Thus, the option object created will have 4 option contracts of quantity 10 each:
CALL2530 +10
CALL2630 −10
CALL2630 −10
CALL2730 +10

This processing of quantity values allows the option object to be tracked or modified using a single quantity value and for the quantity value to always be a positive integer (e.g. Qty=10). Entry or adjustment of option positions is executed on the basis of this common quantity.

The position or sequence of each option contract relative to each other in the command string of the option object ID is important as this provides the system with information on whether the option contract is a debit or credit operation (i.e. whether the quantity is +10 or −10).

For example, the first option contract is a debit operation, the second option contract is a credit operation, the third option contract is a credit operation and the fourth option contract is a debit operation.

Use of syntax in this manner is what enables the option object to have the common quantity as a single value and for that single quantity value to be positive, thus easing the processing of the plurality of option contracts in an option position or plurality of option positions. However, the words and their arrangement in the command string can vary without affecting the command as long as the order or relative position of each option contract is in accordance with the required syntax. Therefore, in another embodiment of the invention, the command that creates an option object for the same iron butterfly option position as above can be:

MAKE OBJECT=2530PUT|2630PUT|2630CALL|2730CALL QUANTITY=10

In an embodiment, the present invention may also create more than one option object for the current trade position. Different option objects belonging to the same trade position have different option object IDs.

While most option positions are made of only up to 4 option contracts, it is possible that an option strategy may require executing more than 4 option contracts to enter or adjust a position. In the event that an option position is made up of more than 4 option contracts, the plurality of required option contracts will be divided and two or more option objects may be created, each option object being processed independent of the other(s). In this instance, these two or more option objects will be regarded as two option positions. The exact number of option objects created is defined by the respective action conditions in relation to the option strategy.

More than one option object may also be created in the rare event that the option position requires quantities of option contracts which do not have a common factor thus no common quantity can be derived. The number of option contracts for each option object created is based on the action conditions of the option position and the highest common factor of their quantities. The exact number of option objects created is defined by the respective action conditions in relation to the common quantity.

Once trigger conditions are met, a plurality of option contracts may be divided selectively based on the respective action conditions of the option strategy, such that one selection of option contracts may be modified without affecting any other group. The trigger conditions defined in the strategy module may provide the information required for two or more option objects to be created for strategic purposes. For example, a position to be entered into has the following option contracts:
PUT2530 +10
PUT2630 −10
CALL2630 −10
CALL2730 +10

If the option strategy has action conditions to adjust the option position by only adjusting the PUT verticals (both of the PUT option contracts), then instead of creating a single option object, two option objects may be created:

ADD ID=P2530/P2630 QTY=10 & ADD ID=C2730/C2630 QTY=10

Creating two option objects would allow the PUT verticals to be modified without affecting the option object made up of CALL verticals (both of the CALL option contracts):

MODIFY ID=P2530/P2630 QTY=5

The adjusted position would then be as follows:
PUT2530 +5
PUT2630 −5
CALL2630 −10
CALL2730 +10

It will be appreciated by a person skilled in the art that this modification is not specific to option types, e.g. an option position made up of 4 CALL option contracts can also be divided into two or more option objects and modified independently.

Option Object Data

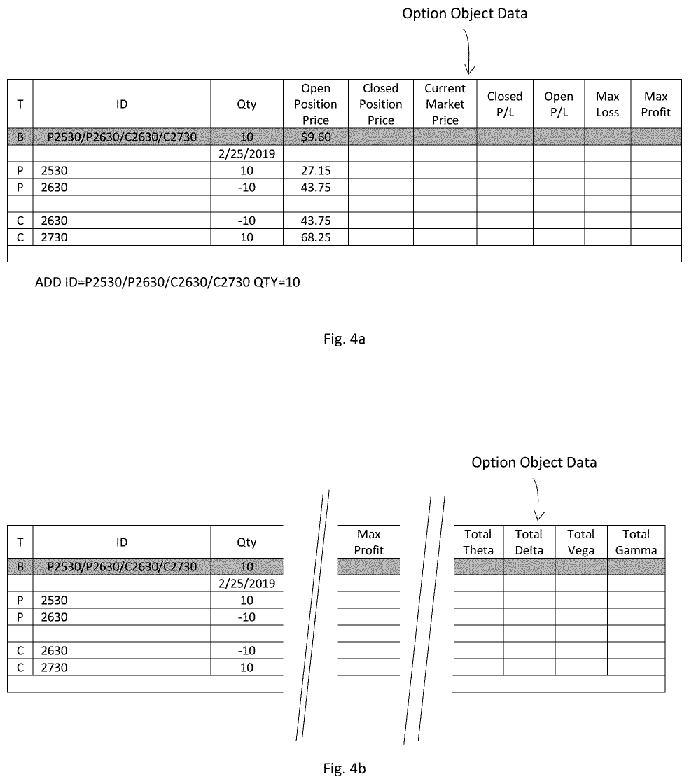

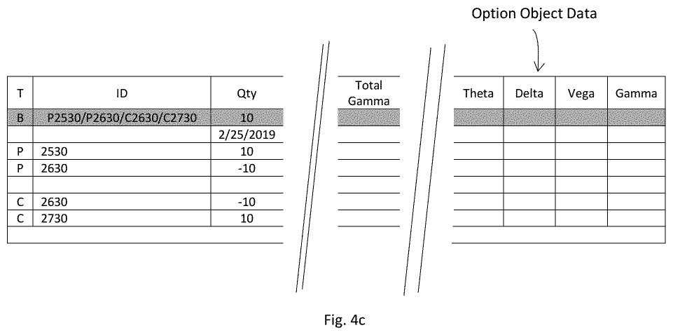

The dynamic data of an option object are an aggregate of the data of the plurality of option contracts that make up the option object. In an embodiment, this data is aggregated, stored, and tracked in the data processing module. This aggregate data may be a summation of the each type of dynamic data of the individual option contracts making up the option object. This is illustrated in FIGS. 4a, 4b, and 4c.

In back testing, historical market data are downloaded into the data processing module to enable the back testing in the strategy module. The historical market data can be downloaded from a remote database server.

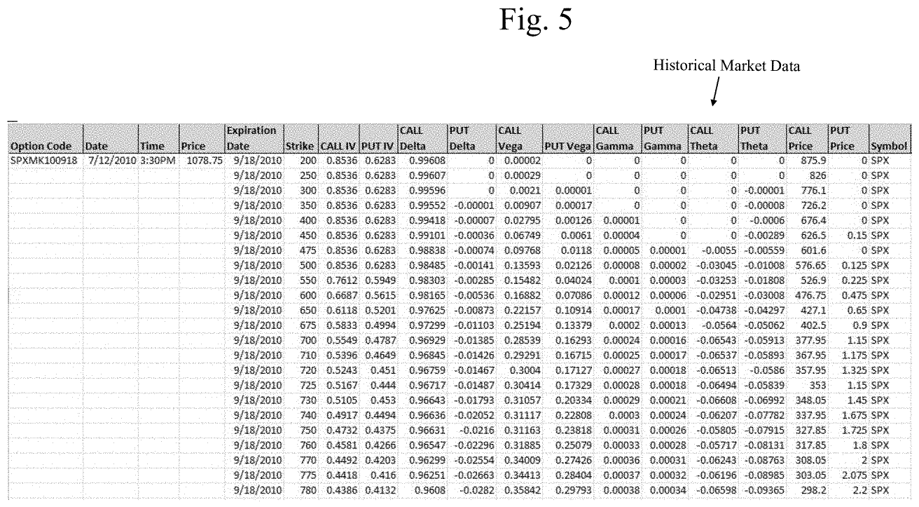

In an embodiment, the historical market data such as VIX values and the entire underlying stock's option Greek data is downloaded and stored in the data processing module. By storing the historical market data in the data processing module itself, the data can be accessed quickly and conveniently, thus reducing access delay often seen in other similar software applications. FIG. 5 shows a section of the downloaded historical market data. The historical market data will remain in the data processing module until another download is initiated, in which case the existing historical market data will be replaced by a new set of historical market data. Any query of the historical market data and VIX values in the data processing module can be done using spreadsheet functions, such as VLOOKUP and MATCH in Microsoft Excel.

In live trading, the dynamic data are received by the data processing module from live data feeds from an external system. RTD function may be used to retrieve live data from a Real-Time Data Server (RTD) server and spreadsheet formula may be used to search the live data. This information is then selectively obtained by the strategy module for checking against its conditions to enter, adjust, or exit an option position.

Entering, Adjusting, and Exiting an Option Position

The trigger conditions and action conditions required by the relevant strategy for a trading campaign are first set in the strategy module. This may be done using spreadsheet formula. The data processing module sends relevant data into the strategy module. This data includes aggregate data of an option object, and market conditions such as days to expiration, strike prices, etc. For the purposes of entering or adjusting an option position, the strategy module receives the data from the data processing module and checks them against the trigger conditions defined by the option strategy. If an entry, adjustment, or exit command is generated, the strategy module sends the command to the data processing module, where the options are executed by sending instructions to an external live trading server during live trading.

The following trigger conditions are used to illustrate how a position is entered using the present invention. The trigger conditions for the purpose of illustration are as follows:
Create an entry position “ATM Iron Butterfly with 50 points butterfly wings” when the following are satisfied:
1. Earliest Date to Expiration (DTE) to open position—60 Days
2. Latest DTE to open position—8 Days
3. Entry credit $35.00

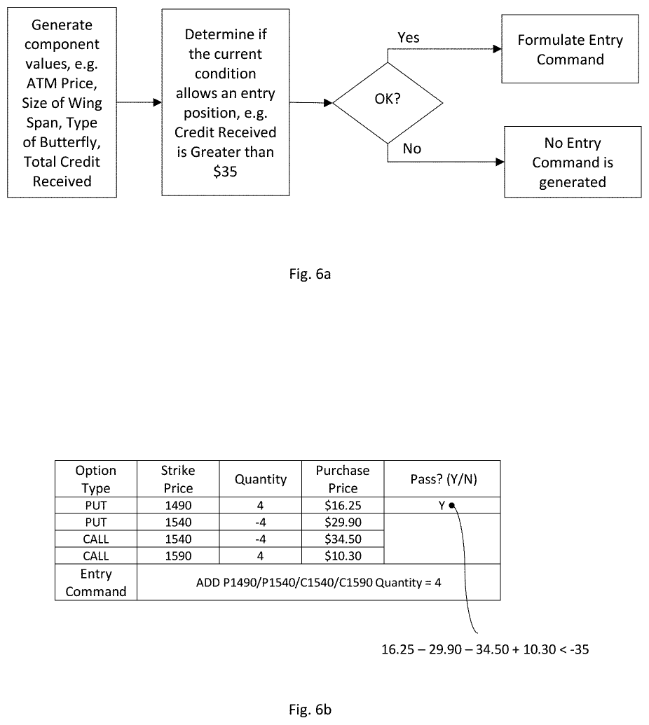

As shown in FIG. 6a, the information is obtained on components required such as the ATM Price, Size of Wing Span, Type of Butterfly Needed and Total Credit Received. The strategy module then determines whether the trigger conditions are satisfied. If so, an entry command is generated and the options may be executed and a corresponding option object may be created on the basis of the common quantity. This is illustrated in FIG. 6b. The action conditions in this case include execution of the option contracts of a specific type (PUT/CALL), at a defined strike price, and of a specific quantity, etc. Spreadsheet formula may be used to perform the functions of obtaining data, making calculations, and assessing trigger conditions.

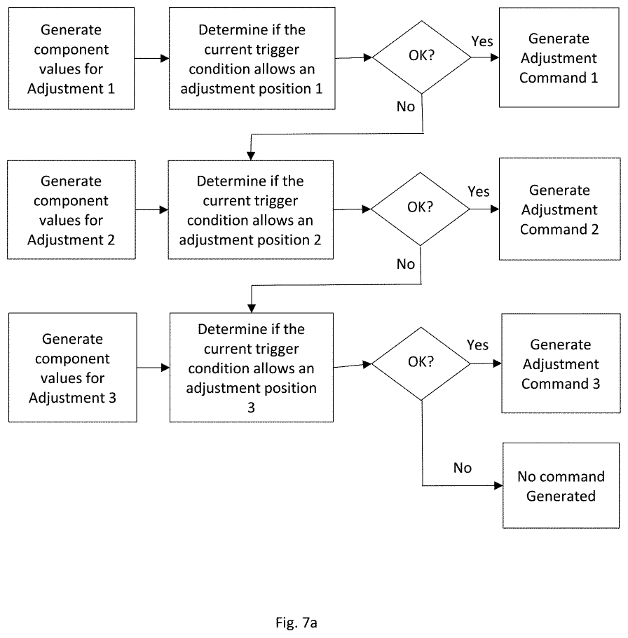

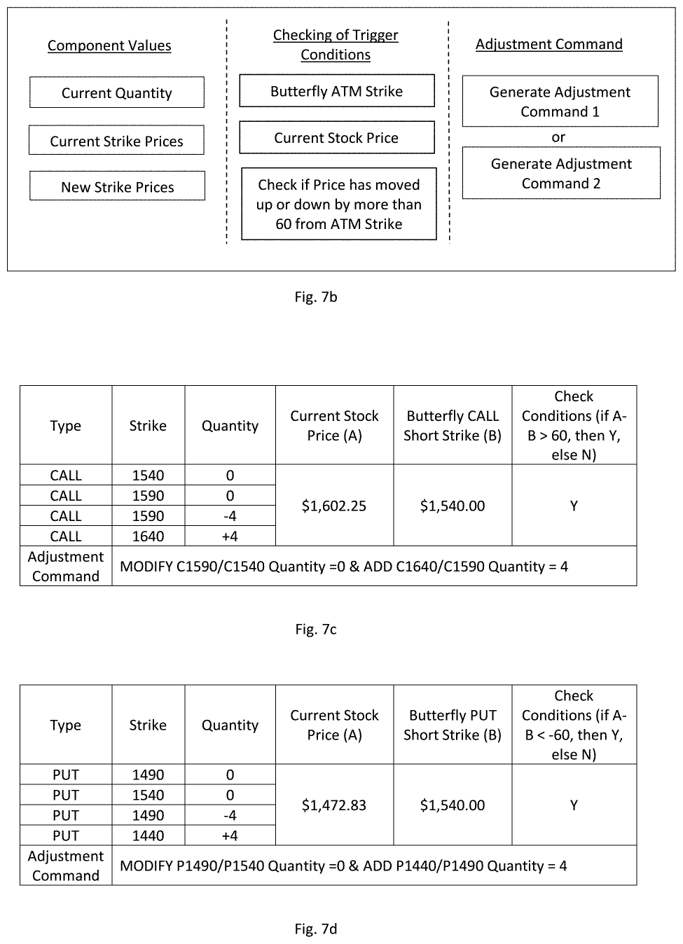

Trigger conditions for adjustment of an option position are similarly evaluated. If all the trigger conditions for adjusting a position are satisfied, an adjustment command is generated. When there is more than one possible adjusted position, the trigger conditions for each adjusted position are evaluated in turn and an adjustment command is generated for the adjusted position for which the trigger conditions are met. This is illustrated in FIG. 7a. The adjustment conditions for the purpose of illustration are as follows:

If current position is an Iron Butterfly with the following option contracts:

| | |
|---|---|
| PUT 1490 | Quantity +4 |
| PUT 1540 | Quantity −4 |
| CALL 1540 | Quantity −4 |
| CALL 1590 | Quantity +4 |

1. If stock price moves higher than the Iron Butterfly CALL short strike by more than 60 points, then adjust by moving the CALL verticals strikes up by 50 points or
2. If stock price moves lower than the Iron Butterfly PUT short strike by more than 60 points, then adjust by moving the PUT verticals strikes down by 50 points.

The strategy module obtains information from the data processing module on the components required such as the current quantity, current strike prices, and new strike prices. The strategy module then determines if the trigger conditions have been met. If so, an adjustment command is generated and the options may be executed on the basis of the common quantity and a corresponding option object may be created. This is illustrated in FIG. 7b.

FIG. 7c shows a situation where the stock price has gone up by more than $60 and FIG. 7d shows a situation where the stock price has gone down by more than $60, which satisfies the trigger conditions. In both cases, an adjustment command is generated, but while the CALL verticals are adjusted in the first case, the PUT verticals are adjusted in the second case—these respective adjustments are the action conditions.

Adjusting an option position may involve modifying the common quantity of an option object, closing an option object (i.e. common quantity set to “0”), addition of a new option object, or all or any combination of the same.

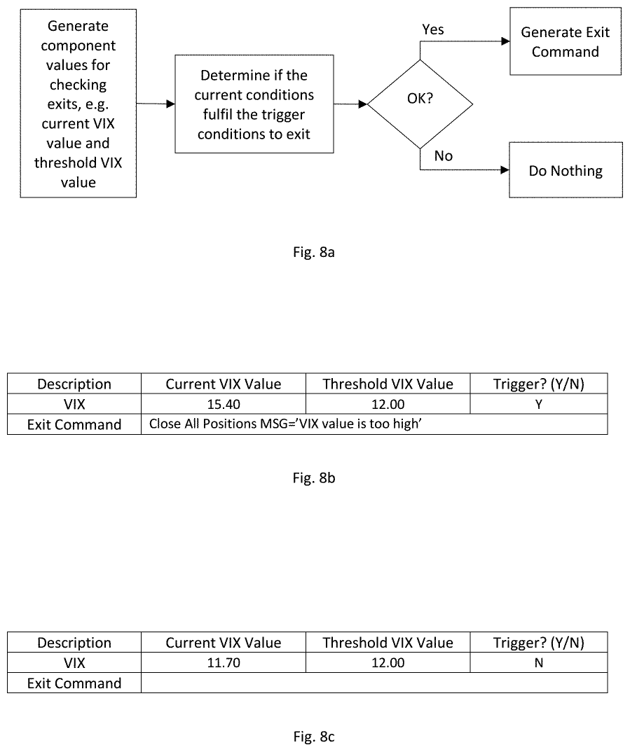

Similarly, exiting an option position also involves evaluating the trigger conditions to exit a position, as shown in FIG. 8a. An exit command may apply to exiting a trade (closing an option object independently or exiting a trade position) or ending a trading campaign entirely.

Unlike entering and adjusting, an option strategy may not require all of the trigger conditions for exiting to be satisfied but only one. The trigger conditions to exit an option position for the purpose of illustration are as follows:

Close the entire position when one of the following conditions is satisfied:
1. Profit 20% of investment capital
2. Loss 20% of investment capital
3. DTE 7 days
4. VIX 12 points

FIG. 8b shows a situation where the current VIX Value is 15.40 and the Threshold VIX Value is 12. One trigger condition for closing the entire position is satisfied and an exit command is generated for closing the entire position, which is executed on the basis of the common quantity of the option object by changing the common quantity to “0”. In the alternative, if none of the trigger conditions for exiting the position is satisfied, no command is generated. This is illustrated in FIG. 8c.

While various aspects and embodiments have been disclosed herein, it will be appreciated by a person skilled in the art that several of the above-disclosed structures, parameters or processes thereof, can be desirably modified, adapted and combined into alternative structures, processes and/or applications. It is intended that all such modifications, alterations, adaptations, and/or improvements made to the various embodiments that are disclosed come within the scope of the present disclosure. The various aspects and embodiments disclosed herein are for purposes of illustration and are not intended to be limiting, with the true scope of the disclosure being indicated by the following claims.

1. A computer-based process of executing an option trading campaign for a plurality of option contracts, comprising:
setting trigger conditions for an option position;
deriving aggregate data from the plurality of option contracts constituting the option position;
generating a common quantity associated with the plurality of option contracts;
executing the plurality of option contracts on the basis of the common quantity, upon market conditions and aggregate data satisfying the trigger conditions; and
selectively dividing the plurality of option contracts into two or more groups according to action conditions, and processing the selectively divided groups of option contracts separately, wherein an option position of one of the selectively divided groups is operable to be adjusted by modifying a quantity of the selectively divided group without affecting any other selectively divided group.

2. The computer-based process according to claim 1, wherein the plurality of option contracts is processed in a group as a whole.

3. The computer-based process according to claim 1, wherein the trading campaign is executed according to the trigger conditions and the action conditions for creating, adjusting, or exiting the option position.

4. The computer-based process according to claim 1, wherein the trading campaign comprises a plurality of option positions and the steps of claim 1 are repeated for each option position.

5. The computer-based process according to claim 3, wherein adjusting the option position comprises modifying the common quantity for the plurality of option contracts.

6. The computer-based process according to claim 3, wherein adjusting the option position comprises adding an option position by repeating the steps of claim 1 at least once.

7. The computer-based process according to claim 3, wherein adjusting the option position comprises modifying the common quantity to “0” to exit a trade.

8. The computer-based process according to claim 4, wherein a number of option contracts processed in the group as a whole during each repetition is defined by the action conditions for the option position or the plurality of option positions.

9. The computer-based process according to claim 2, wherein the group as a whole is assigned a unique identifier (ID) which comprises data selected from at least one of:
each option contract's option type;
each option contract's strike price;
each option contract's quantity; and
whether each option contract is a debit or credit operation.

10. A computer-based option trading system for executing an option trading campaign for a plurality of option contracts, comprising:
a strategy module;
a common quantity associated with the plurality of option contracts;
aggregate data of the plurality of option contracts; and
trigger conditions for entering, adjusting, or exiting an option position, wherein the strategy module is operable to:
process the plurality of option contracts as a whole by using the aggregate data and the common quantity to check against the trigger conditions for entering, adjusting, or exiting the option position; and
selectively divide the plurality of option contracts into two or more groups according to action conditions, and process the selectively divided groups of option contracts separately wherein an option position of one of the selectively divided groups is operable to be adjusted by modifying a quantity of the selectively divided group without affecting any other selectively divided group.

11. The computer-based option trading system according to claim 10, wherein the checking performed by the strategy module results in executing of the plurality of option contracts on the basis of the common quantity.

12. The computer-based system according to claim 10 or 11, further comprising a data processing module operable to work communicatively with the strategy module, wherein the data processing module processes data retrieved from the strategy module and external databases, and the processed data is fed back into the strategy module.

13. The computer-based system according to claim 11, further comprising a data processing module operable to work communicatively with the strategy module, wherein the data processing module processes data retrieved from the strategy module and external databases, and the processed data is fed back into the strategy module.
